(19) United States
(12) Patent Application Publication
(10) Pub. No.: US 2022/0357474 A1
(43) Pub. Date: Nov. 10, 2022

(54) SEISMIC MIGRATION TECHNIQUES FOR IMPROVED IMAGE ACCURACY

(71) Applicant: EMERSON PARADIGM HOLDING LLC, Houston, TX (US)

(72) Inventors: Jianyong BAI, Katy, TX (US); Orhan YILMAZ, Houston, TX (US)

(73) Assignee: EMERSON PARADIGM HOLDING LLC, Houston, TX (US)

(21) Appl. No.: 17/864,536

(22) Filed: Jul. 14, 2022

Related U.S. Application Data
(63) Continuation-in-part of application No. 17/129,062, filed on Dec. 21, 2020.
(60) Provisional application No. 62/930,801, filed on Nov. 5, 2019.
(60) Provisional application No. 63/299,232, filed on Jan. 13, 2022.

(51) Int. Cl. G01V 1/28; G01V 1/30

(52) U.S. Cl. CPC G01V 1/282; G01V 1/303; G01V 2210/614; G01V 2210/51; G01V 2210/679

(57) ABSTRACT

Reducing migration distortions in migrated images of the Earth's subsurface. Recorded seismic data may be migrated, using a migration velocity model, to generate a migration image comprising ADCIGs with distortions. Synthetic seismic data may be generated, using the migration velocity model, for a grid of point scatterers. The synthetic seismic data may be migrated, using the migration velocity model, to generate impulse responses for the point scatterers. The impulse responses are used as point spread functions (PSFs) which approximate the blurring operator, e.g., the Hessian. An optimal reflectivity model may be selected using image-domain least-squares migration (LSM), based on the PSFs, with regularization of the difference between the migration image and a reflectivity model and a total variation (TV) regularization of the reflectivity model in the spatial and angular domains. An image of the optimal reflectivity model may be generated with reduced migration distortions compared to the original migration image.

### CROSS REFERENCE TO RELATED APPLICATIONS

This application is a continuation-in-part of U.S. application Ser. No. 17/129,062, filed Dec. 21, 2020, which claims the benefit of U.S. Provisional Application No. 62/960,801, filed Jan. 14, 2020. This application claims the benefit of U.S. Provisional Application No. 63/299,232, filed Jan. 13, 2022, which is incorporated by reference.

### FIELD OF THE INVENTION

Embodiments of the invention relate to the field of tomographic scanning, and in particular, seismic tomography for generating an image of the interior subsurface of the Earth based on seismic data collected by transmitting a series of incident seismic waves and receiving reflections of those seismic waves at receivers, such as geophones, across geological discontinuities in the subsurface. The incident and reflected waves are reconstituted by a 3D model to generate an image of the reflecting surfaces interior to the Earth. Accordingly, seismic tomography allows geophysicists to “see inside” the Earth without drilling into or disturbing the geology.

Embodiments of the invention further relate to improving the quality of images by implementing image-domain least-squares migration techniques. New techniques are proposed herein to improve seismic migration accuracy to generate tomographic images or angle-domain common image gathers that are more accurate than in conventional systems. These images or angle gathers may aid geoscientists in exploring the subsurface geology for applications such as predicting tectonic motion or Earthquakes, or by exploration engineers in the mining or oil and gas industries.

### BACKGROUND OF THE INVENTION

In geophysics, seismic images and angle gathers of the subsurface layers of the Earth are generated by emitting waves (e.g., sound waves) and recording their reflections off of natural boundaries within the Earth's subsurface, e.g., as shown in FIG. 9. Seismic tomography generates seismic data by combining many seismic wave reflections taken from various angles to generate an image of where seismic events were recorded within the Earth's surface. Seismic migration re-locates seismic events, in space or time, to the location the event occurred in the subsurface rather than the location that it was recorded at the surface, thereby creating a more accurate image of the subsurface geology and allowing geoscientists to “see inside” the Earth surface.

Seismic migration, however, is often distorted due to poor acquisition geometry, a limited aperture of the acquisition geometry, noise, and illumination effects in complex structures. These migration distortions cause images or angle gathers of the subsurface to have poor quality and blurring.

Accordingly, there is a need in the art for techniques to improve the quality of images and angle gathers of the subsurface of the Earth and reduce blurring after seismic migration.

### SUMMARY OF THE INVENTION

The state-of-the-art seismic imaging technologies, such as reverse-time migration (RTM), are standard routines to generate migration images and angle gathers for complex geological structures. However, the migrations and angle gathers can be distorted due to poor acquisition geometry, a limited aperture of the acquisition geometry, and illumination effects.

In order to reduce or correct those migration distortion, embodiments of the invention provide an image-domain least-squares migration (LSM) technique by approximating the Hessian through point spread functions (PSFs) with an Lₚ-norm regularization of the difference between a migration image and a reflectivity model and a total variation (TV) regularization of the reflectivity model. The regularization of the difference is implemented to reduce artifacts and make the reflectivity model similar to the migration image or angle-domain common image gathers, while the TV regularization is implemented to keep the continuity of geological structures.

Embodiments of the invention implement the new LSM scheme through a seismic migration technique such as, RTM. Given a migration velocity model, synthetic seismic data for a grid of point scatterers may be generated through a Born modeling operator and, then, is migrated through RTM to calculate PSFs, which may be angle/azimuth-dependent for improving angle-domain common image gathers. A reflectivity model, which may be angle/azimuth-dependent, is convolved with the PSFs to fit a migration image. Since this problem is a highly nonlinear problem, a nonlinear conjugate gradient method is applied to select an optimal reflectivity model. Results from numerical examples show that embodiments of the invention improve the resolution of migration image and angle gathers and reduce migration artifacts in the image and angle gathers and, therefore, broaden spectrum in wavenumber domain.

Embodiment of the invention provide new techniques after seismic migration that improve the quality and reduce blurring of images and angle gathers of the Earth's subsurface. In some embodiments of the invention, the subsurface of the Earth may be illuminated to record seismic data d with array of sensors or geophones, e.g., as shown in FIG. 9. A migration velocity model, e.g., as shown in FIG. 1B or FIG. 6B, may be generated or obtained and stored. The recorded seismic data d may be migrated, using the migration velocity model, to generate a migration image or angle gathers, m_{mig}, e.g., as shown in FIG. 3A, 5C, 5E, 5G, 6C, or 6E. The migration image, m_{mig}, comprises angle-domain common image gathers (ADCIGs) with migration distortions. Synthetic seismic data may be generated, using the same migration velocity model, for a grid of point scatterers. The synthetic seismic data may be migrated, using the migration velocity model, to generate point spread functions (PSFs) representing impulse responses for the grid of point scatterers to approximate the blurring operator, e.g., the Hessian operator H, e.g., as shown in FIG. 2, 5A or 5B.

An optimal reflectivity model of the Earth's subsurface may be selected using an image-domain least-squares migration (LSM), based on the point spread functions (PSFs), with a nonlinear deblurring function, e.g., equation (4), that regularizes the difference between the migration image m_{mig}, e.g., as shown in FIG. 3A, 5C, 5E, 5G, 6C, or 6E, and a reflectivity model m, and regularizes a total variation (TV) regularization of the reflectivity model. The difference regularization, r(m), may decrease differences between the migration image m_{mig} and the reflectivity model m in the spatial and angular domains. The total variation (TV) regularization may decrease discontinuities (i.e., increase continuity) of geological structures in the reflectivity model m in the spatial and angular domains. The difference regularization and total variation (TV) regularization may be weighted to set the impact of each regularization in the image-domain least-squares migration (LSM). A nonlinear method such as the nonlinear conjugate gradient method may be used to solve the optimization and select the optimal reflectivity model.

Selecting the optimal reflectivity model may include convolving the reflectivity model m with the PSFs, e.g., represented by Hessian operator H, to generate a synthetic migration image Hm. The synthetic migration image Hm may then be compared to the original migration image m_{mig}, e.g., as ½∥Hm−m_{mig}|₂², in the nonlinear deblurring function. To increase the speed and efficiency of this complex and time-consuming convolution, the PSFs may be converted to a sparse matrix and the reflectivity model may be converted to a vector to compute the convolution between the reflectivity model and the PSFs through sparse matrix multiplication.

An image of the selected optimal reflectivity model may be generated, e.g., as shown in FIG. 3C, 3E, 4, 5D, 5F, 5H, 6D or 6F. Due to the various difference and TV regularizations, the optimal reflectivity model image, e.g., as shown in FIG. 3C, 3E, 4, 5D, 5F, 5H, 6D or 6F, may have significantly reduced migration distortions, as compared to the original migration image m_{mig} e.g., as shown in FIG. 3A, 5C, 5E, 5G, 6C, or 6E. Accordingly, the migration techniques according to embodiments of the invention generate the image of the optimal reflectivity model to visualize the geological structures at various depths within the subsurface of the Earth with less distortion than standard migration images.

The benefits of difference regularization are shown in FIGS. 3A-3F. Difference regularization, according to embodiments of the invention, may include an L₂-norm regularization (e.g., used in FIG. 3C) and/or an L₁-norm regularization (e.g., used in FIG. 3E). L₂-norm regularization may converge relatively faster, but provide a coarser optimization, compared to L₁-norm regularization that may converge relatively slower, but provide a more precise optimization. L₁-norm regularization may produce sharper images with less blurring (e.g., see encircled region in FIG. 3E) as compared to L₂-norm regularization (e.g., see encircled region in FIG. 3C). In the wavelength domain, the sharper images obtained using L₁-norm regularization correspond to a wider range of wavenumbers representing the reflectivity model in its Fourier transform (e.g., see FIG. 3F) as compared to L₂-norm regularization (e.g., see FIG. 3D). In some embodiments, a combination of Lₚ regularizations may be used, e.g., a multi-pass regularization, where L₂-norm regularization is used first for its faster global optimization, followed by L₁-norm regularization used to refine the optimization locally for its increased precision.

The benefits of total variation (TV) regularization are shown in FIG. 4. FIG. 4 shows reflectivity models generated using image-domain LSM and L₁-norm regularization, where FIG. 4B uses TV regularization and FIG. 4A does not use TV regularization. Compared to geological structures in FIG. 4A (with no TV regularization), the geological structures in FIG. 4B (with TV regularization) are more continuous (for example, in the rectangular region).

Embodiments of the invention may define data over the spatial domain, the angular domain, or both. Some embodiments may generate images based on angle-domain common image gathers (ADCIGs) that represent reflectivity variations over reflection angles and azimuth. Such embodiments may provide a multi-iteration image-domain least-squares reverse-time migration (LSRTM), for example, with an Lp-norm regularization of the difference between reflectivity and image and with a TV regularization of reflectivity. Embodiments of the invention may extend the LSRTM to the ADCIGs, which may be generated directly from RTM through e.g. Poynting vectors. Given a migration velocity model, synthetic seismic data for a grid of point scatterers may be generated from Born modeling and may be migrated through RTM to calculate the PSFs. The PSFs may be a function of the positions of point scatterers, reflection angles, and azimuth. Embodiments of the invention may use the PSFs to approximate the Hessian. Numerical examples demonstrate that the method uplifts the ADCIGs with improved resolution, balanced amplitudes, enhanced illumination, and extended angular ranges. The same benefits are also observed on angle stacks.

### BRIEF DESCRIPTION OF THE DRAWINGS

The principles and operation of the system, apparatus, and method according to embodiments of the present invention may be better understood with reference to the drawings, and the following description, it being understood that these drawings are given for illustrative purposes only and are not meant to be limiting.

FIG. 1A schematically illustrates an example velocity model used to generate synthetic seismic data of geological structures at various depths within the subsurface of the Earth, and FIG. 1B schematically illustrates a smoothed version of the velocity model in FIG. 1A, according to an embodiment of the invention.

FIG. 2 schematically illustrates blurring and distortions, defined by Point Spread Functions (PSFs), of point scatterers that are distorted from their real-world arrangement in a regular grid, according to an embodiment of the invention.

FIG. 3A schematically illustrates a migration image with migration artifacts and blurring, according to an embodiment of the invention.

FIGS. 3C and 3E schematically illustrate reflectivity models of the migration image of FIG. 3A optimized according to embodiments of the invention to reduce migration artifacts and blurring. The reflectivity models of FIGS. 3C and 3E are generated using image-domain least-squares migration (LSM), with a difference regularization between the migration image of FIG. 3A and the reflectivity model, and a total variation (TV) regularization of the reflectivity model, according to various embodiments of the invention. FIG. 3C uses an L₂-norm difference regularization and FIG. 3E uses an L₁-norm difference regularization.

FIGS. 3B, 3D, and 3F schematically illustrate a range of wavenumbers in Fourier Transforms applied to the migration image FIG. 3A and the reflectivity models of FIGS. 3C and 3E, respectively, according to embodiments of the invention.

FIGS. 4A and 4B schematically illustrate the reflectivity models obtained from the image-domain LSM, without TV regulation (FIG. 4A) and with TV regulation (FIG. 4B), according to an embodiment of the invention. FIGS. 4A and 4B use an L₁-norm difference regularization.

FIG. 5A schematically illustrates PSFs at an example 10° and FIG. 5B schematically illustrates PSFs at an example 30° of point scatterers that are blurred and distorted from their real-world arrangement in a regular grid, according to an embodiment of the invention. FIGS. 5C and D schematically illustrate ADCIGs from 0° to 45° obtained from RTM (FIG. 5C) and LSM (FIG. 5D), according to embodiments of the invention. FIGS. 5E and F schematically illustrate common-angle images of 23° generated from RTM (FIG. 5E) and LSM (FIG. 5F), according to embodiments of the invention. FIGS. 5G and 5H schematically illustrate angle stacks (between 0° and 45°) of ADCIGs from RTM (FIG. 5G) and LSM (FIG. 5F), according to embodiments of the invention.

FIG. 6A schematically illustrates an example SEG Advanced Modeling Program (SEAM) velocity model used to generate synthetic seismic data of geological structures at various depths within the subsurface of the Earth, and FIG. 6B schematically illustrates a smoothed version of the velocity model in FIG. 6A, according to an embodiment of the invention. FIGS. 6C and D schematically illustrate ADCIGs from 0° to 45° obtained from RTM (FIG. 6C) and LSM (FIG. 6D, according to embodiments of the invention. FIGS. 6E and F schematically illustrate angle stacks (between 0° and 45°) of ADCIGs from RTM (FIG. 6E) and LSM (FIG. 6F), according to embodiments of the invention.

FIG. 7 schematically illustrates a system for seismic migration that improves the quality and reduces blurring of images of the Earth's subsurface, according to an embodiment of the invention.

FIG. 8 is a flowchart of a method for seismic migration that improves the quality and reduces blurring of images of the Earth's subsurface, according to an embodiment of the invention.

FIG. 9 schematically illustrates seismic tomography in which a series of incident and reflected waves are propagated through a subsurface region of the Earth to image the subsurface according to an embodiment of the invention.

For simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

Seismic data can be imaged as the result of a forward modeling process through subsurface structures, while seismic migration reverses the forward process, thereby re-locating seismic events to the locations where the events occur in the subsurface and generating an accurate image of the subsurface. The state-of-the-art imaging technologies for complex structures, such as Kirchhoff migration, one-way wave-equation method, and reverse-time migration (RTM), are widely applied to generate seismic images in the petroleum industry. However, seismic migration can be distorted by poor acquisition geometry, a limited aperture of the acquisition geometry, noise, and illumination effects in the complex structures, causing artifacts and blurring in the subsurface images.

In order to remove or reduce the effects of the distortions, embodiments of the invention provide a new least-squares migration (LSM) technique. Data-domain LSM generates synthetic data from a reflectivity model by a linearized Born operator and finds an optimal model so that the synthetic data from the model fits field seismic data in a least-squares sense. Data-domain LSM, however, is prohibitively complex and time-consuming in real-world problems. Image-domain LSM generates an image through the Hessian operator, an operator of demigration followed by migration, from a reflectivity model and find an optimal model so that the image generated from the model fits the raw migrated image. Although standard image-domain LSM is also cumbersome in real-world problems, due to the complex computations of the Hessian and its inverse, image-domain LSM may be performed significantly faster by using point spread functions (PSFs) to approximate the Hessian, and/or using non-stationary matching filters to approximate the inverse of the Hessian. According to embodiments of the invention, regardless of how many iterations are implemented, the image-domain LSM through the PSFs performs computations which are roughly equivalent to three migrations (e.g., two migrations and a Born modeling) in order to find an optimal reflectivity model. Since the optimization is performed in the image-domain, the LSM through the PSFs according to embodiments of the invention is fast and efficient.

In order to reduce artifacts due to incomplete surface data and irregular subsurface illumination in a reflectivity model, embodiments of the invention provide LSM techniques with various constraints. Embodiments of the invention propose image-domain LSM by approximating the Hessian through point spread functions (PSFs) with of an Lₚ-norm regularization of the difference between the migration image and a reflectivity model, and a TV regularization constraint of the reflectivity model. The Lₚ-norm regularization constraint may reduce artifacts in the LSM scheme, while the TV regularization constraint may maintain structural continuities. These constraints significantly reduce blurring and artifacts produced by LSM:
Lₚ-norm regularization: According to embodiments of the invention, either an L₁-norm or an L₂-norm regularization of the difference between a migration image and a reflectivity model is introduced to reduce the artifacts. Additionally or alternatively any Lₚ-norm regularization (p>0) may be used. The regularization reduces the ambiguousness of solution to make sure that the reflectivity model from LSM is always similar to the migration image. Norm regularization decreases or minimizes differences between the reflectivity model and the migration image
Total variation (TV) regularization: TV regularization is added to decrease or minimize discontinuities of geological structures in the reflectivity model, thereby improving structural continuities in a reflectivity model for complex geological setting.

Since this LSM technique includes an Lₚ-norm regularization of the difference between a migration image and a reflectivity model and the TV regularization of the reflectivity mode, optimizing the reflectivity model is a highly nonlinear problem. To solve this, embodiments of the invention use a nonlinear conjugate gradient method to find an optimal reflectivity model that satisfies the above regularization constraints. The gradient direction may be updated through the Fletcher-Reeves formula and a step length may be calculated though a line search.

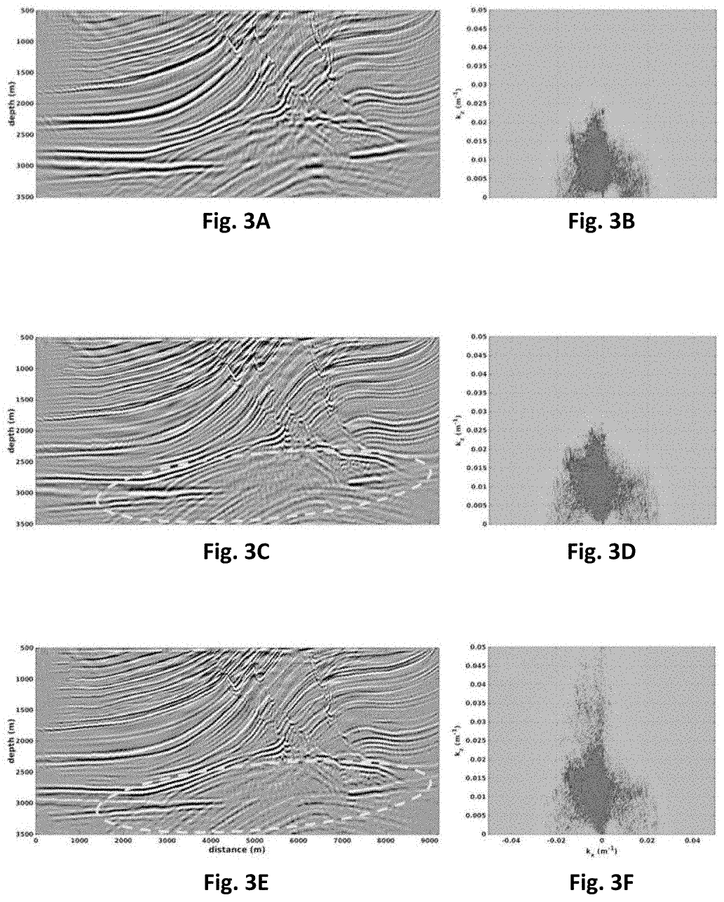

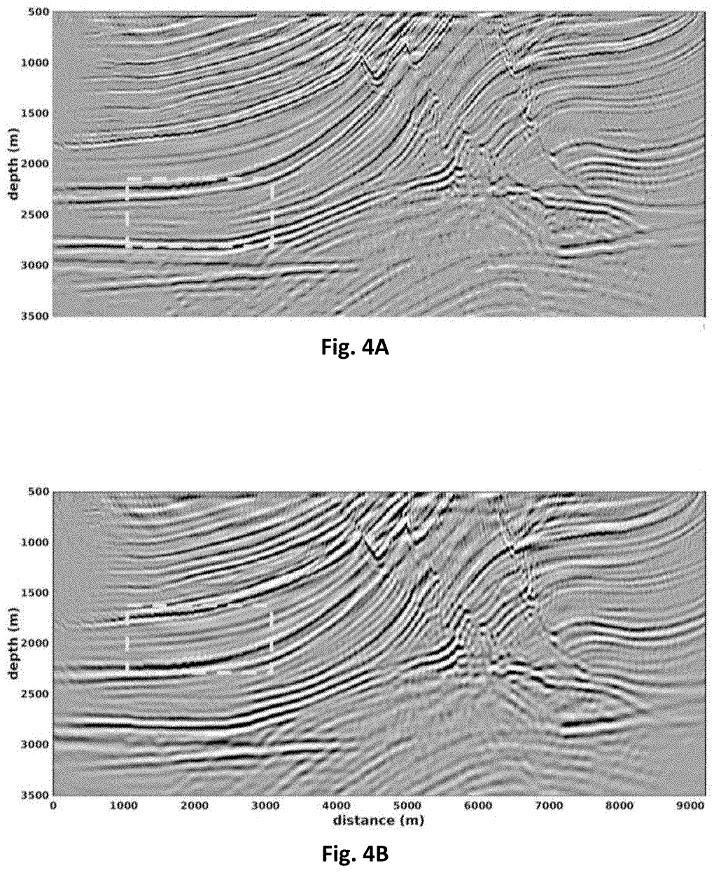

According to some embodiments, the new LSM technique may be implemented using image-domain least-squares migration. Embodiments of the invention may use a migration method, such as, reverse-time migration (RTM), Kirchhoff migration, or a one-way wave-equation technique. A migration velocity model may be obtained by illuminating the Earth's subsurface and performing seismic tomography. The migration velocity model may be used to generate synthetic seismic data for a grid of point scatterers, e.g., through a Born modeling operator. The synthetic seismic data may then be migrated, e.g., through RTM, to calculate PSFs representing impulse responses for the grid of point scatterers, e.g., to approximate the blurring or Hessian operator. A reflectivity model is convolved with the PSFs to fit the migration image. The optimal reflectivity model may be found through a non-linear optimization method, such as, the non-linear conjugate gradient method. Results from numerical examples show that embodiments of the invention improve image resolution and reduce migration artifacts and blurring in the image domain. For example, see the image sharpening of ellipsoid region in FIGS. 3C and 3E, due to L₁ and L₂-norm difference regularization, compared to the blurred corresponding region image in FIG. 3A. Sharper image resolution is also associated with a broader spectrum of wavenumbers (kₓ−k_{z}) that represents the Fourier expansion of the reflectivity model in the wavenumber domain. For example, see the wider range of illuminated wavenumbers in FIG. 3F compared to the narrower range of illuminated wavenumbers in FIG. 3B. See also the increased continuity of the geological structures in FIG. 4B, due to TV regularization, compared to the discontinuous structures in FIG. 4A, without TV regularization.

The convolution between a reflectivity model and PSFs may be implemented in the wavenumber domain or in the spatial domain. In the wavenumber domain, the convolution may be calculated through fast Fourier transform and inverse fast Fourier transform for each imaging point. These are complex and time-consuming operations, particularly for 3D problems. Embodiments of the invention may instead convert the PSFs to a sparse matrix and convert the reflectivity model to a column vector. As a result, the convolution may be calculated through sparse matrix multiplication, instead of through dense matrix multiplication. Such embodiments significantly reduce the time to execute the convolution operation, especially for 3D problems.

According to some embodiment, the image-domain LSM may proceed e.g., as follows:

Given a reflectivity model m, seismic data d may be calculated through a forward modeling operator L, for example, as follows:

d=Lm. (1)

Equation (1) may define the recorded seismic data as d. The subsurface distorts an ideal reflectivity model m by L (e.g., the effect of the subsurface). The forward modeling operator L may be associated with an acquisition geometry, source wavelet and/or physical parameter model(s).

Migration image m_{mig} may be obtained through a migration operator, e.g., the adjoint of the forward modeling operator L:

m_{mig}=L^{T}d. (2)

Equations (1) and (2) result in a relationship between the migration image and the reflectivity model that is, for example:

m_{mig}=Hm, (3)

where H=L^{T}L denotes the Hessian matrix. m_{mig} is the distorted migration model due to the Hessian or blurring operator H. Ideally, when there is no blurring, the Hessian operator H=I, where I is an identity matrix, and m=m_{mig}.

Equation (3) defines that the migration image m_{mig} is a version of the reflectivity model m blurred by the Hessian matrix H. Distortions may therefore be eliminated by canceling H (e.g., by finding and applying its inverse), so equation (3) reduces to m=H⁻¹m_{mig}. However, the inverse of H cannot be solved directly, because its storage and computation are not affordable for real problems, so the inverse of H may be found indirectly, e.g., by minimizing an optimization or error function, such as the nonlinear deblurring function, J, in equation (4).

Embodiments of the invention therefore set up a nonlinear image deblurring technique, which may minimize a nonlinear deblurring function, in order to eliminate the blurring effects caused by the Hessian, e.g., as:

J(m)=½∥Hm−m_{mig}∥₂²+ar(m)+β∫_{Ω}∥∇m∥₁dx, (4)

where ∥⋅∥₂ represents the L₂-norm, ∥⋅∥₁ represents the L₁-norm, ∇m is the gradient of m with respect to the coordinates x in the spatial space Ω, α and β are the weights for the 2nd and 3rd terms, respectively.

The 1st term of J is the least-squares difference between the reflectivity model m and the migration image m_{mig} (e.g., the blurring error).

The 2nd term in J, r(m), is a regularization of the difference between the reflectivity model m and the migration image m_{mig}. The regularized difference, r(m), is an Lₚ-norm, where Lₚ-norm regularization defines a difference between the reflectivity model m and the migration image m_{mig}, e.g., r (m)=∥m−m_{mig}∥₂^{p}/p. The 2nd term reduces the difference between m and m_{mig} so that the reflectivity model is as similar as possible to the migration image m_{mig}, in light of the other parameters. Difference regularization, r, may be an L₁-norm regularization (1^{st} order difference), an L₂-norm regularization (e.g., square of differences), or an Lₚ-norm regularization with p>0. In some embodiments, L₂-norm regularization may be better for a rougher optimization (e.g., converging faster to a general region or relatively coarse neighborhood) compared to L₁-norm regularization. Whereas, once within the general region, L₁-norm regularization may be better for a finer optimization (e.g., converging faster to a local or smaller region or relatively finer neighborhood and in particular to the best single model) compared to L₂-norm regularization. In some embodiments, multiple difference regularization phases or iterations may be used, first an L₂-norm regularization for a fast global optimization, followed by a local tuning optimization with an L₁-norm regularization pass.

The 3rd term in J is the total variation (TV) regularization, which aggregates changes in the reflectivity model m, e.g., discontinuities defined by its gradient in space, which when minimized in J, can decrease or eliminate discontinuity/increase the continuity of geological structures in the reflectivity model m.

Weight parameters α and β may indicate the relative weights of the norm regularization and TV regularization constraints, respectively. Weight parameters α and β may be determined, e.g., according to variances or generalized cross-validation.

The objective function J in equation (4) is highly non-linear, due to the 2nd regularization term and the 3rd TV regularization term, and so, is solved using a nonlinear model, such as, the nonlinear conjugate gradient method for the optimal model m to minimize J.

Other operations and equations may also be used.

One of the key steps is approximating the Hessian matrix H through PSFs. Using the migration velocity model, embodiments of the invention generate synthetic seismic data for a grid of point scatters through the linearized Born forward operator. The synthetic data is then migrated through RTM to get impulse responses, the PSFs which represent the Hessian, at each point scatterer. The Hessian for every image point is obtained by interpolation from the surrounding computed PSFs and is convolved with the reflectivity model m.

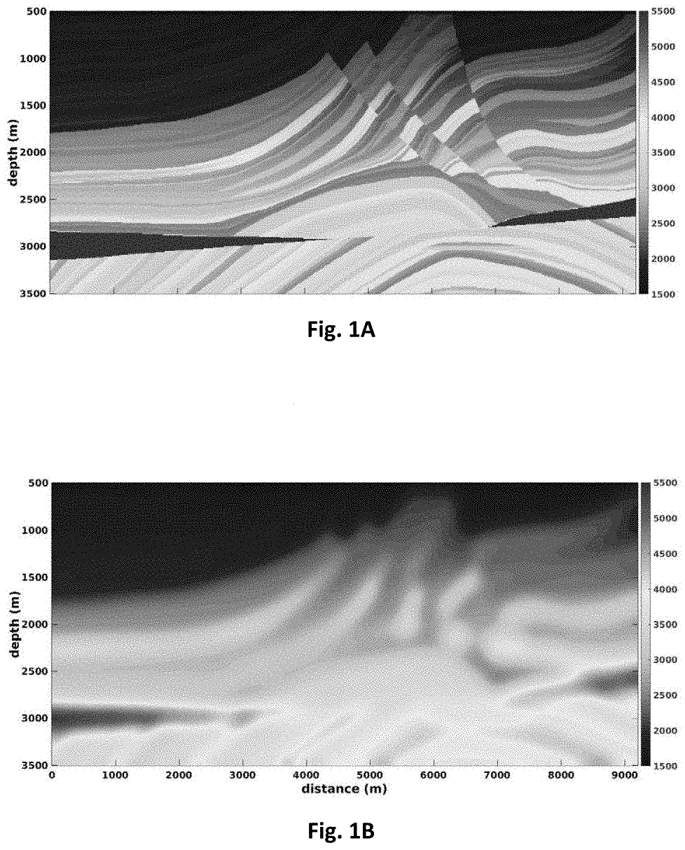

Reference is made to FIGS. 1A and 1B, which are used when applying the LSM technique, according to some embodiments of the invention, to an example modified Marmousi model which contains a water body from the surface down to a depth of 500 meters. FIG. 1A shows the original velocity model, and FIG. 1B shows a smoothed version of the model in FIG. 1A. The forward modeling operator L and the migration operator L^{T} are based on a two-way wave-equation solved by the finite-difference (FD) method in time-space domain.

Embodiments of the invention may approximate the Hessian e.g., by Born modeling, followed by RTM to a grid of point scatterers in the velocity space under water. The smoothed velocity model shown in FIG. 1B may be used for the purpose. In order to capture significant variations in illumination and blurring effects and, at the same time, avoid the adjacent PSFs overlapping, the interval of point scatterers is chosen to be e.g., 400 meters in both directions. The Born modeling generates synthetic data with a record length of e.g., 4 seconds. The synthetic data includes e.g., 115 shots with a shot interval of e.g., 80 meters. Each shot gather has e.g., 921 receivers with a receiver interval of e.g., 10 meters. A Ricker wavelet with the peak frequency of e.g., 15 Hz is used. The synthetic data is then migrated to get the impulse responses for each point scatterer, which are known as PSFs.

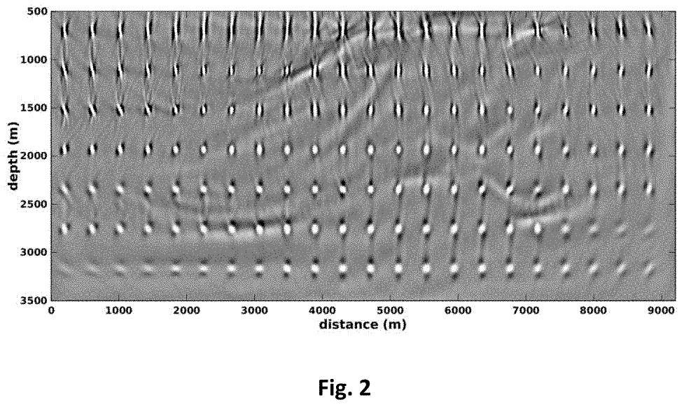

Reference is made to FIG. 2, which shows the PSFs for a regular grid of point scatterers simultaneously, according to some embodiments of the invention. This array shows the result of distortion of a regular grid of points into the blurred array seen in the figure, where points are stretched into blobs. Significant variations are observed in both directions among the computed PSFs. For a location where PSF is not computed, embodiments of the invention may calculate its PSF through the interpolation of its surrounding PSFs.

The distortion of the regular point grid in FIG. 2 is caused by noise, limited aperture, layers casting shadows, and other illumination and migration errors. Point Spread Functions (PSFs) model this distortion of the array of points, by the Hessian or “blurring” operator H. A goal of embodiments of the invention is to eliminate or reduce this blurring effect to sharpen blurry images of the Earth's subsurface.

Although FIG. 2 shows a rectangular grid, a grid as used herein may refer to any arrangements or array of point scatterers, regular or irregular, such as a random array of point scatterers or a circular, elliptical, or polyhedron arrangement of point scatterers.

Using the same acquisition geometry and Ricker wavelet, embodiments of the invention generate synthetic seismic data from the velocity model shown in FIG. 1A. The 2nd synthetic data is migrated with the smoothed velocity model shown in FIG. 1B. Reference is made to FIG. 3A, which shows the migration image. Since the velocity models are different for the modeling and RTM, migration artifacts and blurring are observed.

The LSM of the migration image is computed with r(m) being the L₁-norm and the L₂-norm in equation (4). In order to find optimal reflectivity models, a plurality of (e.g., 50) iterations are implemented in the non-linear conjugate gradient method.

The resulting reflectivity models are displayed in FIGS. 3C and 3E, respectively. In both FIGS. 3C and 3E, the reflectivity models are generated using image-domain least-squares migration (LSM), with a difference regularization between the migration image of FIG. 3A and the reflectivity model, and a total variation (TV) regularization of the reflectivity model. FIG. 3E uses an L₁-norm difference regularization and FIG. 3C uses an L₂-norm difference regularization. Both the reflectivity models FIGS. 3C and 3E reduce migration artifacts as compared to FIG. 3A. Further, compared to the results with r(m) being the L₂-norm in FIG. 3C, r(m) being the L₁-norm in FIG. 3E produces much sharper and more continuous seismic events (especially in the encircled region) in the reflectivity model.

FIGS. 3B, 3D, and 3F schematically illustrate the range of wavenumbers used in Fourier Transforms of the migration image FIG. 3A and the reflectivity models of 3C, and 3E, respectively, according to embodiments of the invention. In the wavelength domain, r(m) being the L₁-norm in FIG. 3F produces a much wider range of wavelengths (kₓ−k_{z}) in the Fourier domain, associated with sharper images, as compared to the results with r(m) being the L₂-norm in FIG. 3D, and the results of migration image in FIG. 3B.

Reference is made to FIGS. 4A and B schematically illustrate the reflectivity models obtained from the image-domain LSM, without TV regulation (FIG. 4A) and with TV regulation (FIG. 4B), according to an embodiment of the invention. FIGS. 4A and B use an L₁-norm difference regularization. These figures show that TV regularization, which is used in FIG. 4B, but not in FIG. 4A, is helpful to maintain geological continuities as indicted in the rectangular region in FIG. 4B.

Embodiments of the invention may be extended to generate images of the subsurface based on angle-domain common image gathers (ADCIGs) that represent reflectivity variations over reflection angles and azimuth. ADCIGs may be used for velocity analysis and amplitude versus angle (AVA) analysis. Migration technologies, such as reverse-time migration (RTM), may be used to generate the ADCIGs.

To address ADCIG migration image issues arising from, for example, complex geologic structures, irregular acquisition geometry, limited recording apertures, limited seismic frequency band, and inaccurate wave propagation through inaccurate models of physical properties, least-squares migration (LSM) has demonstrated a capability to improve a migrated image in structural details and amplitude fidelity for reservoir characterization. When applied to the ADCIGs, LSM may compensate the angle gather amplitudes as well. Data-domain angle/azimuth-dependent LSM algorithms match the observed seismic data by predicting seismic data from an angle/azimuth reflectivity model. This may be accomplished by establishing a relationship between the reflectivity model and predicted seismic data. Image-domain LSM matches the ADCIGs from migration by the ADCIGs predicted from an angle/azimuth-dependent reflectivity model through a Hessian matrix. Since the computation and storage of Hessian or its reverse may be computationally too complex and time-consuming for real problems, it may be appropriate to approximate the Hessian or its inverse.

In practice, in order to partially compensate the ADCIGs through the LSM for the velocity analysis and AVA analysis, embodiments of the invention approximate the Hessian by the angle/azimuth-dependent PSFs, so the image-domain angle/azimuth-dependent LSM is rendered relatively simply computationally for real problems. Accordingly, the image-domain LSM may be chosen according to embodiments of the invention. This may address the difficulty and computational complexity of computing the data-domain angle/azimuth-dependent LSM and computation and storage of the angle/azimuth-dependent Hessian and its inverse, which may be too complex for real problems.

It may be challenging to predict seismic data or ADCIGs from an angle/azimuth-dependent reflectivity model in LSM. For example, in the data-domain LSM, it may present a challenge to predict seismic data from the reflectivity model. An optimal reflectivity model may be obtained by matching recorded seismic data and predicted seismic data. Likewise, in the image-domain LSM, it is typically a challenge to compute or approximate the Hessian or its inverse and use them to predict ADCIGs from the model. According to embodiments of the invention, given a migration velocity model, the angle/azimuth-dependent PSFs may be calculated on a grid of point scatterers from Born modeling followed by RTM. The PSFs may be calculated directly from e.g. the Poynting vectors of source/receiver wavefields or the Poynting vectors of source wavefields and the dips of reflectors in RTM. The Hessian at other points may be obtained by interpolation from surrounding computed PSFs on the grid. The PSFs may be used to approximate the Hessian. According to embodiments of the invention, ADCIGs may be predicted directly from the convolution of the approximated Hessian and an angle/azimuth-dependent reflectivity model. Because the convolution computation may be complex and time-consuming, especially for 3D problems, in embodiments of the invention, the PSFs may be converted to a sparse matrix and the reflectivity model may be converted to a column vector. As a result, the convolution may be calculated through sparse matrix multiplication. Sparse matrix multiplication is a simple and fast way for the convolution computation, especially for 3D problems. Memory is saved for the storage of the Hessian.

Other embodiments of the invention address artifacts produced by LSM. The LSM may cause artifacts by itself. According to embodiments of the invention, an Lₚ-norm regularization of the difference between the ADCIGs and an angle/azimuth-dependent reflectivity model may be introduced to reduce the artifacts. The regularization also reduces the ambiguousness of solution to make sure that the reflectivity model from the LSM is similar (approximately equivalent) to the ADCIGs from migration. A TV regularization may be added to maintain structural continuities in an angle/azimuth-dependent reflectivity model for complex geological setting. A weighting function may be used to avoid degrading the optimal angle/azimuth-dependent reflectivity model in the LSM due to the complex geological structures, for example, salt bodies.

Since the LSM scheme according to some embodiments of the invention includes the Lₚ-norm regularization of the difference between ADCIGs and an angle/azimuth-dependent reflectivity model and the TV regularization of the reflectivity mode, the optimal problem is a highly nonlinear problem. Embodiments of the invention may use a nonlinear conjugate gradient method to find an optimal model. The gradient direction may be updated e.g., through Fletcher-Reeves formula and a step length may be calculated through line search.

Given an angle/azimuth-dependent reflectivity model m(x, Θ) at the spatial position x for the angles Θ, the ADCIGs m_{mig}(x, Θ) may be calculated through the Hessian matrix H (x, Θ)

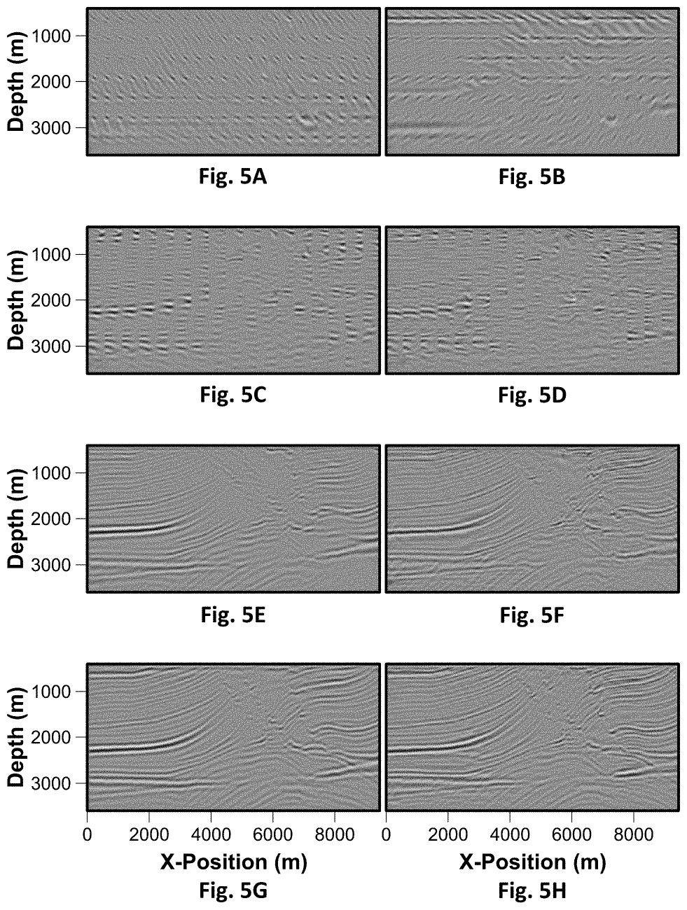

m_{mig}=L^{T}Lm=Hm, (5)

where Θ=(θ, ϕ) involves the reflection angle θ and the azimuth φ, L is a forward modeling operator, and L^{T}, the adjoint of L, is a migration operator. Equation (5) states that the ADCIGs m_{mig} are a version of the reflectivity model m blurred (e.g., decreased in resolution, as seen by ideal points occupying circular areas in FIG. 5A or 5B) by the Hessian H=L^{T}L. Embodiments of the invention therefore set up a nonlinear deblurring operation, e.g., which minimizes the following objective function J(m) in order to eliminate the blurring effects:

$$J ( m ) = \frac{1}{2} {‖ Hm - W {m}_{m i g} ‖}_{2}^{2} + \frac{α}{p} {‖ m - W {m}_{m i g} ‖}_{1}^{p} + β \int {\int }_{Ω} {‖ ∇ m ‖}_{1} dxd Θ , \qquad ( 6 )$$

where ∥⋅∥₂ and ∥⋅∥₁ represent L₂- and L₁-norm, respectively, p is a positive number, W=W(x) is a weighting function, ∇m is the gradient of m with respect to x and Θ in the spatial and angular space Ω, α and β are regularization parameters. The weighting function may reduce or avoid degrading the deblurring quality due to, for example, salt bodies. The optimization problem may be ill-posed since m_{mig} does not have enough information to uniquely determine a plausible model m and, moreover, noise in m_{mig} complicates the deblurring problem. Consequently, regularizations may be applied to mitigate these ill-posedness and complications. In Equation (6), the second term,

$$\frac{α}{p} {‖ m - W {m}_{m i g} ‖}_{1}^{p} ,$$

may reduce the artifacts in m and make sure that m is always similar to m_{mig}, while the 3rd term, β∫∫_{Ω} ∥∇m∥₁ dxdΘ, is a TV regularization which maintains the continuity of geological structures in m. A nonlinear conjugate gradient method may be used to iteratively minimize J(m).

According to embodiments of the invention, the ADCIGs may be produced directly from RTM through the Poynting vectors. Propagation directions of seismic waves may be calculated using the Poynting vectors. In RTM, most energetic wavefields and their corresponding propagation directions may be picked from the Poynting vectors and wavefield snapshots. The ADCIGs may be built up by mapping each shot's migration image to angle and azimuth planes, for example, either using the Poynting vectors of source/receiver sides or using the Poynting vectors of source side and the dips of reflectors, which may be estimated from the stack image of shot profiles.

Embodiments of the invention may approximate the Hessian H through the PSFs. Using the migration velocity model, embodiments of the invention may generate synthetic seismic data for a grid of point scatterers, e.g., through linearized Born forward modeling operator. The synthetic data may then be migrated through RTM to produce the ADCIGs, e.g., the PSFs, which approximate the Hessian. The PSFs may represent the impulse responses of an angle/azimuth-dependent reflectivity model with constant amplitudes (e.g. =1) at each scatterer and, therefore, show the AVA responses. The spacing of point scatterers may be controlled by the factors such as subsurface structures, acquisition geometry, velocity model, imaging frequency, and so on. The Hessian at other image points may be obtained by interpolation from surrounding computed PSFs.

The method was illustrated through 2D numerical examples. First, the method was tested with the modified Marmousi model (FIG. 1A). The Hessian was generated with Born modeling followed by RTM to a grid of point scatterers by using the smoothed velocity model (FIG. 1B). In order to capture significant variations in illumination and blurring effects and, at the same time, avoid the effects due to the adjacent PSFs, the interval of scatterers was chosen to be 400 meters. The synthetic data of Born modeling had a record length of 4.5 seconds and includes 249 shots with a shot interval of 50 meters. Each shot gather had 281 receivers with a receiver interval of 10 meters. A Ricker wavelet with the peak frequency of 15 Hz was used. Note that the PSFs change with their positions and reflection angles (FIGS. 5A and 5B).

Using the same wavelet and acquisition parameters, another synthetic dataset was generated from the velocity model in FIG. 1A through seismic forward modeling. The synthetic data was migrated with the smoothed velocity model in FIG. 1B. The migration was carried out with an incorrect model to simulate a realistic situation, which results in migration artifacts and unflattening events (FIG. 5C). The method was carried out with p=1 and unit weighting in Equation (6). The optimal ADCIGs from the LSM is displayed in FIG. 5D. Common-angle images at 23° are compared in FIGS. 5E and 5F. As seen in the figures, the LSM reduces migration artifacts, significantly improves the resolution of angle gathers, and distributes energy in extended angular ranges. The LSM also uplifts angle stacks (FIGS. 5G and 5H) with balanced amplitudes, enhanced resolution, and improved signal-to-noise ratio.

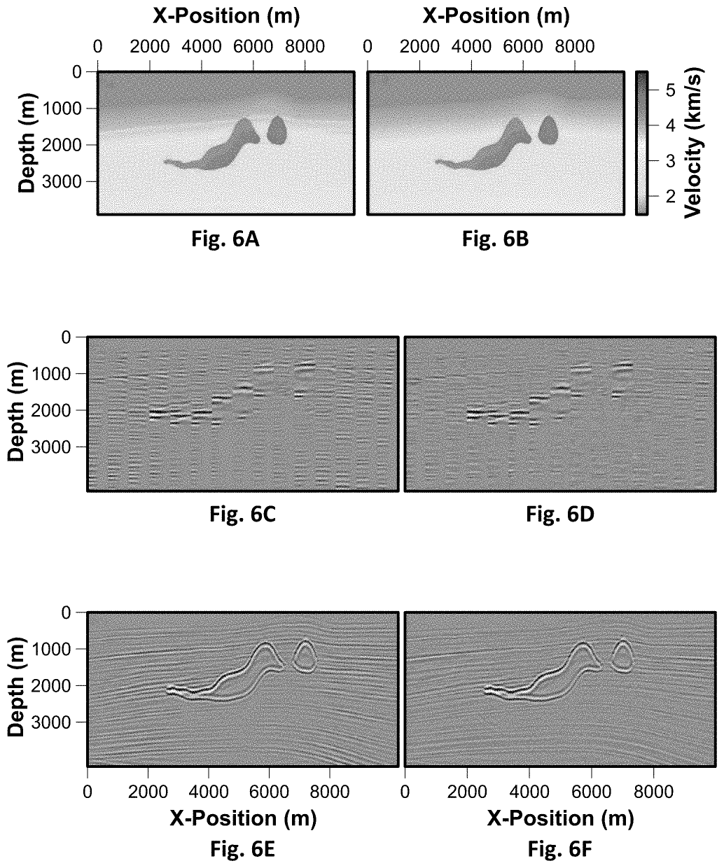

Second, the method was tested by using a section of SEAM model with two salt structures (FIG. 6A). The left salt structure includes a region of dirty salt with sediment inclusions, which cause rapid velocity changes. The right salt structure is a clean homogeneous salt body. The velocities of sediment around the salt structures were smoothed (FIG. 6B). Using the smoothed model, angle-dependent PSFs were generated. Synthetic data from Born modeling had 201 shots with a shot interval of 50 meters and a record length of 4.5 seconds. Each shot gather included 801 receivers with a receiver interval of 10 meters.

Another synthetic dataset was generated from the velocity model in FIG. 6A through seismic forward modeling and, then, the data was migrated with the smoothed model in FIG. 6B. Some ADCIGs are displayed in FIG. 6C. The LSRTM was implemented with p=1 in Equation (6). A weighting function was applied to mute salt energy which may degrade image quality around salt boundary. The LSRTM improves the ADCIGs (FIG. 6D) with enhanced resolution and balanced amplitudes. The same benefits were obtained on angle stacks (FIGS. 6E and 6F). Poor illumination beneath the salt structures was compensated. However, some artifacts beneath the salt structures are also observed due to the poor illumination and coherent noise (e.g., multiples and diffractions which linearized Born modeling cannot simulate) caused by the complex salt structures.

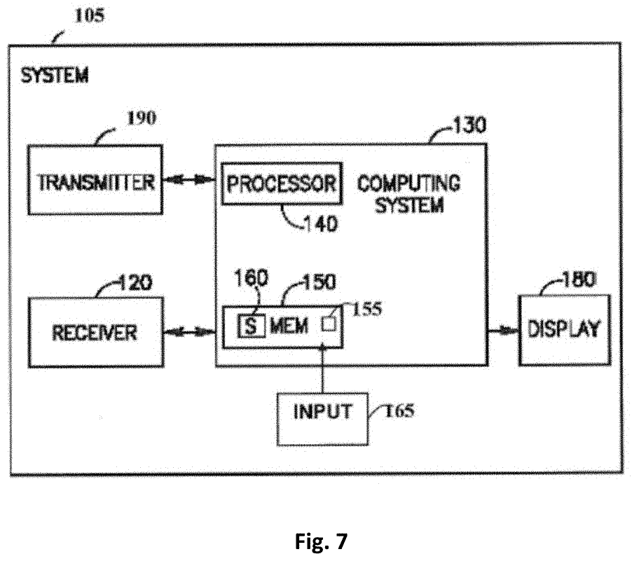

Reference is made to FIG. 7, which schematically illustrates a system 105 for seismic migration that improves the quality and reduces blurring of images of the Earth's subsurface, according to an embodiment of the invention.

System 105 may include one or more transmitter(s) 190, one or more receiver(s) 120, a computing system 130, and a display 180.

The one or more transmitter(s) 190 may be configured to illuminate the Earth's subsurface by emitting energy rays or waves, e.g., sonic waves, seismic waves, compression waves, etc. in a land or marine survey.

The one or more receiver(s) 120 may be configured to receive seismic data, which is the reflections of those emitted waves at boundaries of the Earth's subsurface, and are collected by a set of sensors or geophones.

Computing system 130 may include, for example, any suitable processing system, computing system, computing device, processing device, computer, processor, or the like, and may be implemented using any suitable combination of hardware and/or software. Computing system 130 may include for example one or more processor(s) 140, memory 150 and software 160. Data 155 measured by the set of sensors or geophones and received by receiver 120, may be transferred, for example, to computing system 130. The data may be stored in the receiver 120 as for example digital information and transferred to computing system 130 by uploading, copying or transmitting the digital information. Processor 140 may communicate with computing system 130 via wired or wireless command and execution signals.

Memory 150 may include cache memory, long term memory such as a hard drive, and/or external memory, for example, including random access memory (RAM), read only memory (ROM), dynamic RAM (DRAM), synchronous DRAM (SD-RAM), flash memory, volatile memory, non-volatile memory, cache memory, buffer, short term memory unit, long term memory unit, magnetic tape, or other suitable memory units or storage units. Memory 150 may store instructions (e.g., software 160) and data 155 to execute embodiments of the aforementioned methods, steps and functionality (e.g., in long term memory, such as a hard drive). Data 155 may include, for example, raw seismic data collected by receiver 120, synthetic seismic data, migration velocity model(s), migration image(s), point spread functions (PSFs), Hessian matrices, candidate and optimal reflectivity models, etc., and any other data or instructions necessary to perform the disclosed embodiments of the present invention. Data 155 may also include intermediate data generated by these processes and data to be visualized, such as data representing graphical models to be displayed to a user. Memory 150 may store intermediate data. System 130 may include cache memory which may include data duplicating original values stored elsewhere or computed earlier, where the original data may be relatively more expensive to fetch (e.g., due to longer access time) or to compute, compared to the cost of reading the cache memory. Cache memory may include pages, memory lines, or other suitable structures. Additional or other suitable memory may be used.

Computing system 130 may include a computing module having machine-executable instructions. The instructions may include, for example, a data processing mechanism (including, for example, embodiments of methods described herein) and a modeling mechanism. These instructions may be used to cause processor 140 using associated software 160 programmed with the instructions to perform the operations described. Alternatively, the operations may be performed by specific hardware that may contain hardwired logic for performing the operations, or by any combination of programmed computer components and custom hardware components.

Embodiments of the invention may include an article such as a non-transitory computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

Display 180 may display data from transmitter 190, receiver 120, or computing system 130 or any other suitable systems, devices, or programs, for example, an imaging program or a transmitter or receiver tracking device. Display 180 may include one or more inputs or outputs for displaying data from multiple data sources or to multiple displays. For example, display 180 may display a simulation of a 2D or 3D optimal reflectivity model.

Input device(s) 165 may include a keyboard, pointing device (e.g., mouse, trackball, pen, touch screen), or cursor direction keys, for communicating information and command selections to processor 140. Input device 165 may communicate user direction information and command selections to the processor 140.

Processor 140 may include, for example, one or more processors, controllers or central processing units (“CPUs”). Software 160 may be stored, for example, in memory 150. Software 160 may include any suitable software, for example, migration software.

A method for reducing migration distortions in migrated images of the Earth's subsurface based on seismic data recorded by receiver 120 may be performed by software 160 being executed by processor 140 manipulating the data.

The processor 140 may be configured to migrate recorded seismic data, using a migration velocity model, to generate a migration image comprising migration distortions; generate synthetic seismic data, using the migration velocity model, for a grid of point scatterers; migrate the synthetic seismic data by a migration method, using the migration velocity model, to generate point spread functions (PSFs) representing impulse responses for the grid of point scatterers to approximate the blurring or Hessian operator; select an optimal reflectivity model of the Earth's subsurface using an image-domain least-squares migration (LSM), based on the point spread functions (PSFs), with a regularization of the difference between the migration image and a reflectivity model and a total variation (TV) regularization of the reflectivity model, wherein the difference regularization decreases differences between the reflectivity model and the migration image and the total variation (TV) regularization decreases discontinuities of geological structures in the reflectivity model; and generate an image of the optimal reflectivity model reducing the migration distortions to visualize the geological structures at various depths within the subsurface of the Earth.

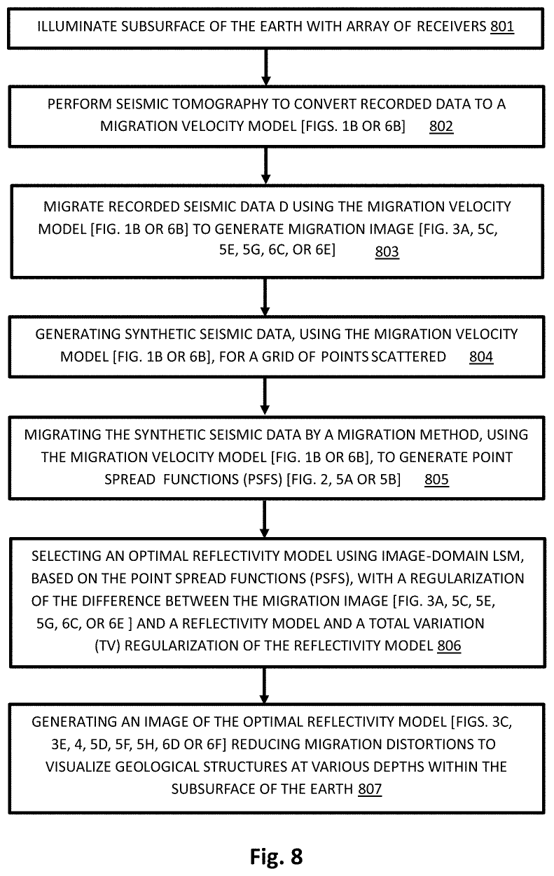

Reference is made to FIG. 8, which is a flowchart of a method for seismic migration that improves the quality and reduces blurring of images of the Earth's subsurface, according to an embodiment of the invention. Operations 801-807 may be performed by one or more processors (e.g., 140 of FIG. 7).

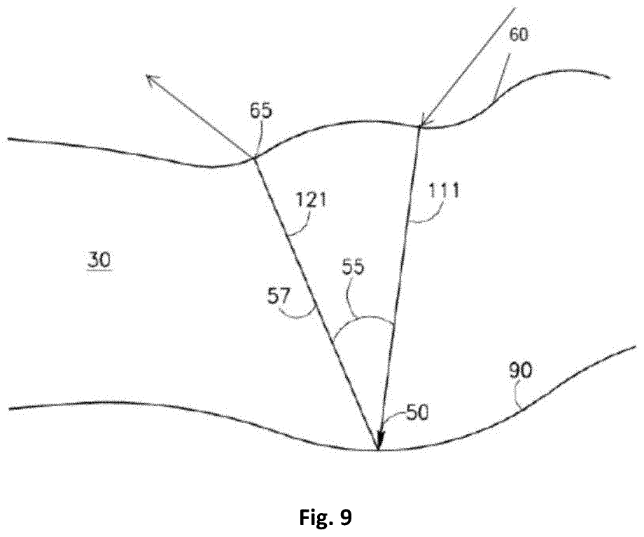

In operation 801, one or more processor(s) (e.g., 140 of FIG. 7) may illuminate the subsurface of the Earth to record seismic data d with array of sensors or geophones, e.g., as shown in FIG. 9.

In operation 802, the one or more processor(s) may perform seismic tomography to convert the record seismic data d to generate a migration velocity model, e.g., as shown in FIG. 1B or 6B.

In operation 803, the one or more processor(s) may migrate the recorded seismic data d, using the migration velocity model, e.g., as shown in FIG. 1B or 6B, to generate a migration image, m_{mig}, e.g., as shown in FIG. 3A, 5C, 5E, 5G, 6C, or 6E. The migration image, m_{mig}, comprises angle-domain common image gathers (ADCIGs) with migration distortions, visible as blurring in the image.

In operation 804, the one or more processor(s) may generate synthetic seismic data, using the same migration velocity model, e.g., as shown in FIG. 1B or 6B, for a grid of point scatterers. The synthetic seismic data may be generated using a Born modeling operator.

In operation 805, the one or more processor(s) may migrate the synthetic seismic data, using the migration velocity model, e.g., as shown in FIG. 1B or 6B, to generate point spread functions (PSFs) representing impulse responses for the grid of point scatterers, e.g., to approximate the blurring operator or Hessian, as shown in FIG. 2, 5A, or 5B. The migration method may include reverse-time migration (RTM), Kirchhoff migration, and/or a one-way wave-equation technique.

In operation 806, the one or more processor(s) may select an optimal reflectivity model of the Earth's subsurface using an image-domain least-squares migration (LSM), based on the point spread functions (PSFs), with a regularization of the difference between the migration image m_{mig}, e.g., as shown in FIG. 3A, 5C, 5E, 5G, 6C, or 6E, and a reflectivity model m, and a total variation (TV) regularization of the reflectivity model. The difference regularization, r(m), may decrease differences between the migration image m_{mig} and the reflectivity model m in the spatial domain (e.g., a 3D Cartesian domain such as (x,y,z)) and angular domain (e.g., a 2D domain such as Θ=(θ, ϕ) comprising the reflection angle θ dimension and the azimuth φ dimension). The total variation (TV) regularization may decrease discontinuities (i.e., increase continuity) of geological structures in the reflectivity model m. The difference regularization and total variation (TV) regularization may be weighted to set the impact of each regularization in the image-domain least-squares migration (LSM). Their weights may be determined, e.g., according to variances or generalized cross-validation. A nonlinear method such as the nonlinear conjugate gradient method may be used to solve the optimization and select the optimal reflectivity model.

Selecting the optimal reflectivity model may include convolving the reflectivity model m with the PSFs, e.g., represented by Hessian operator H, to generate a synthetic migration image Hm. The synthetic migration image Hm may then be compared to the original migration image m_{mig}, e.g., as ½∥Hm−m_{mig}∥₂², in a nonlinear deblurring function, e.g., equation (4) or (6). The convolution Hm between the reflectivity model and the PSFs may be implemented in a spatial or wavenumber domain. To increase the speed and efficiency of this complex and time-consuming convolution, the PSFs may be converted to a sparse matrix and the reflectivity model may be converted to a (e.g, column) vector to compute the convolution between the reflectivity model and the PSFs through sparse matrix multiplication.

In operation 807, the one or more processor(s) may generate an image of the selected optimal reflectivity model, e.g., as shown in FIG. 3C, 3E, 4, 5D, 5F, 5H, 6D or 6F. Due to the various difference and TV regularizations, the optimal reflectivity model image, e.g., as shown in FIG. 3C, 3E, 4, 5D, 5F, 5H, 6D or 6F, may have significantly reduced migration distortions, as compared to the original migration image m_{mig} e.g., as shown in FIG. 3A, 5C, 5E, 5G, 6C, or 6E. Accordingly, the LSM techniques according to embodiments of the invention generate the image of the optimal reflectivity model to visualize the geological structures at various depths within the subsurface of the Earth with less distortion than standard migration images.

The difference regularization, according to embodiments of the invention, may include an L₂-norm regularization (e.g., used in FIG. 3C) and/or an L₁-norm regularization (e.g., used in FIG. 3E). L₂-norm regularization may converge relatively faster, but provide a coarser optimization, compared to L₁-norm regularization that may converge relatively slower, but provide a more precise optimization. L₁-norm regularization may produce sharper images with less blurring (e.g., see encircled region in FIG. 3E) as compared to L₂-norm regularization (e.g., see encircled region in FIG. 3C). In the wavelength domain, the sharper images obtained using L₁-norm regularization correspond to a wider range of wavenumbers representing the reflectivity model in its Fourier transform (e.g., see FIG. 3F) as compared to L₂-norm regularization (e.g., see FIG. 3D). In some embodiments, a combination of L₁ and L₂-norm regularization may be used, e.g., a multi-pass regularization, where L₂-norm regularization is used first for its faster optimization, followed by L₁-norm regularization used to refine the optimization for its increased precision.

Other operations or orders of the operations may be used.

Reference is made to FIG. 9, which is a schematic illustration of a geological tomography technique in which a series of incident rays 111 and reflected rays 121 are propagated through a subsurface region of the Earth 30 to image the subsurface, according to an embodiment of the invention.

One or more transmitter(s) (e.g., 190 of FIG. 7) located at incident location(s) 60 may emit a series of incident rays 111. Incident rays 111 may include for example a plurality of energy rays related to signal waves, e.g., sonic waves, seismic waves, compression waves, etc. Incident rays 111 may be incident on, and reflect off of, a subsurface structure or surface 90 at a reflection point 50. Multiple reflection points 50 may be identified or imaged or displayed in conjunction to display, for example, a horizon.

One or more receiver(s) (e.g., 140 of FIG. 7), such as sensors or geophones, located at reflected location(s) 65 may receive the reflection rays 121. Reflection rays 121 may be the reflected images of incident rays 111, for example, after reflecting off of image surface 90 at target point 50. The angle of reflection 55 may be the angle between corresponding incident rays 111 and reflected rays 121 at reflection point 50. An incident rays 111 and corresponding reflected rays 121 may propagate through a cross-section of a subsurface structure 30. Incident rays 111 may reflect off of a subsurface feature 90 at a reflection point 50, for example, a point on an underground horizon, the seafloor, an underground aquifer, etc.

One or more processor(s) (e.g., 120 of FIG. 7) may reconstitute incident and reflected rays 111 and 121 to generate an image the subsurface 30 using an imaging mechanism. For example, a common reflection angle migration (CRAM) imaging mechanism may image reflection points 50 by aggregating all reflected signals that may correspond to a reflection point, for example, reflected signals that may have the same reflection angle. In other examples, imaging mechanisms may aggregate reflected signals that may have the same reflection offset (distance between transmitter and receiver), reflected angle and/or azimuth, travel time, or other suitable conditions.

The processor(s) may perform seismic tomography (e.g., Operation 802 of FIG. 8) to compose all of the reflection data points 50 to generate a migration velocity model (e.g., FIG. 1B or 6B) of the present-day underground subsurface of the Earth 30. One or more display(s) (e.g., 180 of FIG. 7) may visualize the present-day subsurface image 30.

In the foregoing description, various aspects of the present invention have been described. For purposes of explanation, specific configurations and details have been set forth in order to provide a thorough understanding of the present invention. However, it will also be apparent to one skilled in the art that the present invention may be practiced without the specific details presented herein. Furthermore, well known features may have been omitted or simplified in order not to obscure the present invention. Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the invention may manipulate data representations of real-world objects and entities such as underground geological features, including faults and other features. The data may be generated by tomographic scanning, as discussed in reference to FIG. 9, e.g., received by for example a receiver receiving waves generated e.g., by an air gun or explosives, that may be manipulated and stored, e.g., in memory 150 of FIG. 7, and data such as images representing underground features may be presented to a user, e.g., as a visualization on display 180 of FIG. 7.

When used herein, a subsurface image or model may refer to a computer-representation or visualization of actual geological features such as horizons and faults that exist in the real world. Some features when represented in a computing device may be approximations or estimates of a real world feature, or a virtual or idealized feature. A model, or a model representing subsurface features or the location of those features, is typically an estimate or a “model”, which may approximate or estimate the physical subsurface structure being modeled with more or less accuracy.

Although L1/L2 regularization are tested, additionally or alternatively, Lp regularization (p is a positive number and p is not 1 or 2) may be used.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1. A method to generate an image of reflectivity of the Earth's subsurface, the method comprising:
migrating recorded seismic data, using a migration velocity model, to generate a migration image comprising angle-domain common image gathers (ADCIGs) with migration distortions;
generating synthetic seismic data, using the migration velocity model, for a grid of point scatterers;
migrating the synthetic seismic data by a migration method, using the migration velocity model, to generate point spread functions (PSFs) representing impulse responses for the grid of point scatterers;
selecting an optimal reflectivity model of the Earth's subsurface using an image-domain least-squares migration (LSM), based on the point spread functions (PSFs), with a regularization of the difference between the migration image and a reflectivity model and a total variation (TV) regularization of the reflectivity model, wherein the difference regularization decreases differences between the reflectivity model and the migration image in the spatial and angular domains and the total variation (TV) regularization decreases discontinuities of geological structures in the reflectivity model in the spatial and angular domains; and
generating an image of the optimal reflectivity model reducing the migration distortions to visualize the geological structures at various depths within the subsurface of the Earth.

2. The method of claim 1, wherein the difference regularization is an Lₚ-norm regularization.

3. The method of claim 1, wherein the angular domain varies along a reflection angle and azimuth of tomographic rays in the recorded seismic data.

4. The method of claim 1, wherein the difference regularization and total variation (TV) regularization are weighted to set the impact of each regularization in the image-domain least-squares migration (LSM).

5. The method of claim 1, wherein the migrating method is reverse-time migration (RTM), Kirchhoff migration, or a one-way wave-equation technique.

6. The method of claim 1, wherein the synthetic seismic data is generated through a Born modeling operator.

7. The method of claim 1, wherein the point spread functions (PSFs) represent the Hessian operator.

8. The method of claim 1 comprising performing a nonlinear conjugate gradient method to select the optimal reflectivity model of the Earth's subsurface.

9. The method of claim 1, wherein selecting the optimal reflectivity model comprises convolving the reflectivity model with the PSFs to generate a synthetic migration image to compare via least squares the migration image.

10. The method of claim 9 comprising converting the PSFs to a sparse matrix and converting the reflectivity model to a vector to compute the convolution between the reflectivity model and the PSFs through sparse matrix multiplication.

11. The method of claim 9, wherein the convolution between the reflectivity model and the PSFs is performed in the spatial and angular domains.

12. A non-transitory computer-readable storage medium having instructions stored thereon, which when executed, cause one or more processors to:
migrate recorded seismic data, using a migration velocity model, to generate a migration image comprising angle-domain common image gathers (ADCIGs) with migration distortions;
generate synthetic seismic data, using the migration velocity model, for a grid of point scatterers;
migrate the synthetic seismic data by a migration method, using the migration velocity model, to generate point spread functions (PSFs) representing impulse responses for the grid of point scatterers;
select an optimal reflectivity model of the Earth's subsurface using an image-domain least-squares migration (LSM), based on the point spread functions (PSFs), with a regularization of the difference between the migration image and a reflectivity model and a total variation (TV) regularization of the reflectivity model, wherein the difference regularization decreases differences between the reflectivity model and the migration image in the spatial and angular domains and the total variation (TV) regularization decreases discontinuities of geological structures in the reflectivity model in the spatial and angular domains; and
generate an image of the optimal reflectivity model reducing the migration distortions to visualize the geological structures at various depths within the subsurface of the Earth.

13. The non-transitory computer-readable storage medium of claim 12, wherein the difference regularization is an Lₚ-norm regularization, the migrating method is reverse-time migration (RTM), Kirchhoff migration, or a one-way wave-equation technique, and the point spread functions (PSFs) represent the Hessian operator.

14. The non-transitory computer-readable storage medium of claim 12 having further instructions stored thereon, which when executed, cause the one or more processors to weight the difference regularization and total variation (TV) regularization to set the impact of each regularization in the image-domain least-squares migration (LSM).

15. The non-transitory computer-readable storage medium of claim 12 having further instructions stored thereon, which when executed, cause the one or more processors to generate the synthetic seismic data using a Born modeling operator.

16. The non-transitory computer-readable storage medium of claim 12 having further instructions stored thereon, which when executed, cause the one or more processors to perform a nonlinear conjugate gradient method to select the optimal reflectivity model of the Earth's subsurface.

17. The non-transitory computer-readable storage medium of claim 12 having further instructions stored thereon, which when executed, cause the one or more processors to select the optimal reflectivity model by convolving the reflectivity model with the PSFs to generate a synthetic migration image to compare via least squares the migration image.

18. The non-transitory computer-readable storage medium of claim 17 having further instructions stored thereon, which when executed, cause the one or more processors to convert the PSFs to a sparse matrix and converting the reflectivity model to a vector to compute the convolution between the reflectivity model and the PSFs through sparse matrix multiplication.

19. The non-transitory computer-readable storage medium of claim 17 having further instructions stored thereon, which when executed, cause the one or more processors to perform the convolution between the reflectivity model and the PSFs in the spatial and angular domains.

20. A system to generate an image of reflectivity of the Earth's subsurface, the system comprising:
one or more processors configured to:
migrate recorded seismic data, using a migration velocity model, to generate a migration image comprising angle-domain common image gathers (ADCIGs) with migration distortions,
generate synthetic seismic data, using the migration velocity model, for a grid of point scatterers,
migrate the synthetic seismic data by a migration method, using the migration velocity model, to generate point spread functions (PSFs) representing impulse responses for the grid of point scatterers,
select an optimal reflectivity model of the Earth's subsurface using an image-domain least-squares migration (LSM), based on the point spread functions (PSFs), with a regularization of the difference between the migration image and a reflectivity model and a total variation (TV) regularization of the reflectivity model, wherein the difference regularization decreases differences between the reflectivity model and the migration image in the spatial and angular domains and the total variation (TV) regularization decreases discontinuities of geological structures in the reflectivity model in the spatial and angular domains, and
generate an image of the optimal reflectivity model reducing the migration distortions; and
a display screen configured to display the image of the optimal reflectivity model to visualize the geological structures at various depths within the subsurface of the Earth.

21. The system of claim 20, comprising an array of receivers to record the recorded seismic data.
